(19) United States
(12) Patent Application Publication
(10) Pub. No.: US 2014/0033589 A1
(43) Pub. Date: Feb. 6, 2014

(54) FIREARM RECEIVER AND METHOD OF MANUFACTURE

(71) Applicant: MAG Tactical Systems, LLC, Bargersville, IN (US)

(72) Inventor: William Carr King, JR., Newburgh, IN (US)

(21) Appl. No.: 14/055,779

(22) Filed: Oct. 16, 2013

Related U.S. Application Data
(60) Provisional application No. 61/735,254, filed on Dec. 10, 2012.

(51) Int. Cl. F41A 3/66; B23P 17/04; B23P 15/00

(52) U.S. Cl. CPC F41A 3/66; B23P 15/00; B23P 17/04
USPC 42/75.01; 29/527.5; 29/527.4; 29/428

(57) ABSTRACT

A firearm receiver taking the form of a thixotropically molded magnesium alloy body. The receiver can be a lower receiver adapted for use in a modular rifle having both an upper receiver securable to a barrel and a lower receiver housing a trigger assembly. The receiver may also be nickel plated. Also disclosed is a method of manufacturing a firearm receiver that includes thixotropically molding the receiver out of a magnesium alloy. In some embodiments, the molded receiver defines substantially all openings and slots in the firearm receiver before conducting any post-molding processing steps on the receiver. The receiver may be nickel plated using an electroless nickel plating process. In some embodiments, the receiver has a surface roughness, Rₐ, that is between approximately 35 microinches and approximately 60 microinches. The receiver may be molded out of an AZ91D magnesium alloy.

### CROSS REFERENCE TO RELATED APPLICATIONS

This application claims priority under 35 U.S.C. 119(e) of U.S. provisional patent application Ser. No. 61/735,254 filed on Dec. 10, 2012 entitled FIREARM RECIEVER AND METHOD OF MANUFACTURE the disclosure of which is hereby incorporated herein by reference.

### BACKGROUND OF THE INVENTION

1. Field of the Invention

The present invention relates to firearms and, more particularly, to firearm receivers and methods of manufacturing firearm receivers.

2. Description of the Related Art

Firearms generally include three main parts, the barrel through which a projectile, e.g., a bullet, is fired; the action which includes the moving parts that provide for the loading, firing, ejection of fired casing, and unloading; and either a stock (shotguns and rifles) or grip (handguns). The receiver houses most, if not all, of the operating parts that form the action of the firearm. The receiver is often made out of steel or aluminum. Under U.S. law, the receiver is generally the legally controlled part that is considered to constitute the firearm itself and which has a serial number fixed thereon.

While many firearms have a unitary receiver, some have multiple receivers. For example, one common form of firearm, often referred to as an AR-style rifle, has both an upper and lower receiver which are detachably secured together. This type of rifle gets its name from the AR-15 originally introduced by Armalite and which was adopted by the U.S. military as the M-16 rifle. The M-16 is a selective fire weapon capable of both semi-automatic and fully automatic operation. A civilian version of the M-16 capable only of semi-automatic fire was subsequently developed by Colt's Manufacturing Company and sold as the Colt AR-15. For AR-style rifles, the lower receiver generally constitutes the serialized component that is legally controlled as a firearm.

AR-style rifles are modular rifles which include an upper receiver assembly having an upper receiver, a bolt carrier, a barrel and a handguard. The lower receiver assembly includes a lower receiver which houses a trigger assembly and has a port for receiving a magazine. A pistol grip and stock can be attached to the lower receiver.

The modular nature of the rifle provides several benefits. For example, it allows the rifle to be easily customized for a particular application. The modular nature of the rifle also allows an individual component or one of the sub-assemblies to be easily replaced if the original is damaged or an alternative design is preferred. The many advantages provided by AR-style rifles have led such rifles to become one of the most popular styles of firearm produced today.

While conventional AR-style rifle designs and manufacturing techniques are capable of producing satisfactory rifles, improved cost-efficiency in the manufacture of such rifles and design modifications which improve the manufacturability remain desirable.

### SUMMARY OF THE INVENTION

The present invention provides a magnesium receiver that allows for the cost-efficient and rapid manufacture of firearms using such a receiver. In one embodiment, the receiver is a lower receiver for an AR-style rifle.

The invention comprises, in one form thereof, a firearm receiver taking the form of a thixotropically molded magnesium alloy body. The magnesium alloy body can be adapted for use in a modular rifle having both an upper receiver securable to a barrel and a lower receiver housing a trigger assembly, the upper receiver being securable with the lower receiver wherein the magnesium alloy body is adapted to be the lower receiver. The magnesium alloy body may also be nickel plated.

The invention comprises, in another form thereof, a firearm including a receiver with a thixotropically molded magnesium alloy body, a trigger assembly operably coupled with the receiver, and a barrel operably coupled with the receiver.

The firearm may take the form of a modular rifle having an upper receiver securable to the barrel and a lower receiver housing the trigger assembly and wherein the magnesium alloy body is the lower receiver. The magnesium alloy body is advantageously nickel plated.

The invention comprises, in yet another form thereof, a method of manufacturing a firearm receiver that includes thixotropically molding a magnesium alloy to form a molded body and further processing the molded body to form the receiver. The molded body advantageously defines substantially all openings and slots in the firearm receiver before conducting any post-molding processing steps on the receiver. The method may also include nickel plating the molded body using an electroless nickel plating process.

In some embodiments, the molded body has a surface roughness, Rₐ, that is between approximately 35 microinches and approximately 60 microinches after molding and without any post-molding processing to smooth the surface. The molded body may be formed out of an AZ91D magnesium alloy.

In some embodiments, the molded body is molded to have a configuration which adapts the molded body for use in a modular rifle having both a lower receiver housing a trigger assembly and an upper receiver securable to a barrel. In some embodiments, the molded body is adapted to form the lower receiver. In still other embodiments, the method may further include the step of assembling a modular rifle with the molded body forming the lower receiver of the rifle.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a side view of a firearm having a magnesium lower receiver.

FIG. 2 is another side view of the firearm.

FIG. 3 is view of the firearm broken down into several major sub-assemblies.

FIG. 4 is an exploded view of the lower receiver and extension assembly, buttstock and grip.

FIG. 5 is a perspective view of the lower receiver.

FIG. 6 is an end view of the lower receiver.

FIG. 7 is a bottom view of the lower receiver.

FIG. 8 is a side view of the lower receiver.

FIG. 9 is a top view of the lower receiver.

FIG. 10 is another end view of the lower receiver.

FIG. 11 is another side view of the lower receiver.

FIG. 12 is a cross sectional view of the lower receiver taken along line 12-12 of FIG. 9.

FIG. 13 is a schematic depiction illustrating the molding of the lower receiver.

FIG. 14 is a depiction of a lower receiver after it has been removed from a mold and before any further processing steps have been performed.

FIG. 15 is another depiction of a lower receiver after it has been removed from a mold and before any further processing steps have been performed.

FIG. 16 is a flow chart representing the manufacture of a lower receiver and its assembly in a firearm.

Corresponding reference characters indicate corresponding parts throughout the several views. Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION OF THE INVENTION

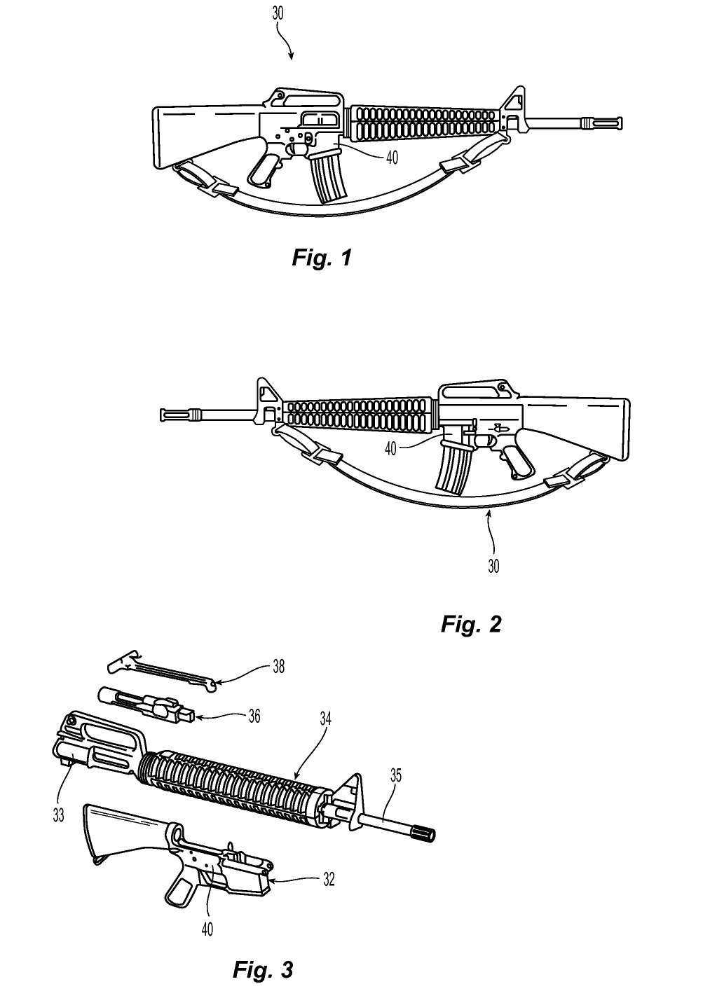

A firearm 30 having a lower receiver in accordance with the present invention is shown in FIGS. 1-3 with the major sub-assemblies of firearm 30 being labeled in FIGS. 1 and 2. Firearm 30 is an AR-style rifle and, except for lower receiver 40, has a conventional design and construction which is well-known to those having ordinary skill in the art.

FIG. 3 illustrates firearm 30 with several of the major sub-assemblies being disconnected. More specifically, firearm 30 has been broken down to separate the lower receiver and extension assembly 32, the upper receiver and barrel assembly 34, the bolt and carrier group 36, and the charging handle 38. These sub-assemblies, e.g., lower receiver and extension assembly 32 and upper receiver and barrel assembly 34, can be further broken down into still smaller modular assemblies.

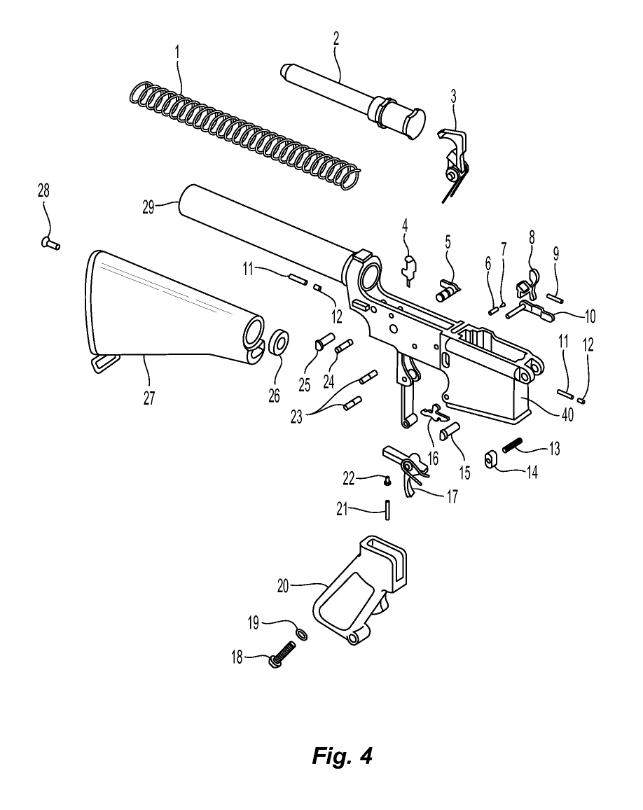

FIG. 4 provides an exploded view of the lower receiver and extension assembly 32. Illustrated in FIG. 4 are helical compression spring 1, buffer assembly 2, hammer assembly 3, sear 4, selector lever 5, helical compression spring 6, bolt catch plunger 7, bolt catch 8, spring steel pin 9, magazine catch 10, helical compression spring 11, pin 12, helical compression spring 13, magazine catch button 14, pivot pin 15, disconnector 16, trigger assembly 17, screw 18, lock washer 19, grip 20, helical compression spring 21, safety detent 22, grooved pin 23, grooved pin 24, takedown pin 25, stepped spacer 26, buttstock assembly 27, self-locking screw 28 and receiver extension tube 29. The assembly and operation of the parts shown in FIG. 4 will be understood by those having ordinary skill in the art.

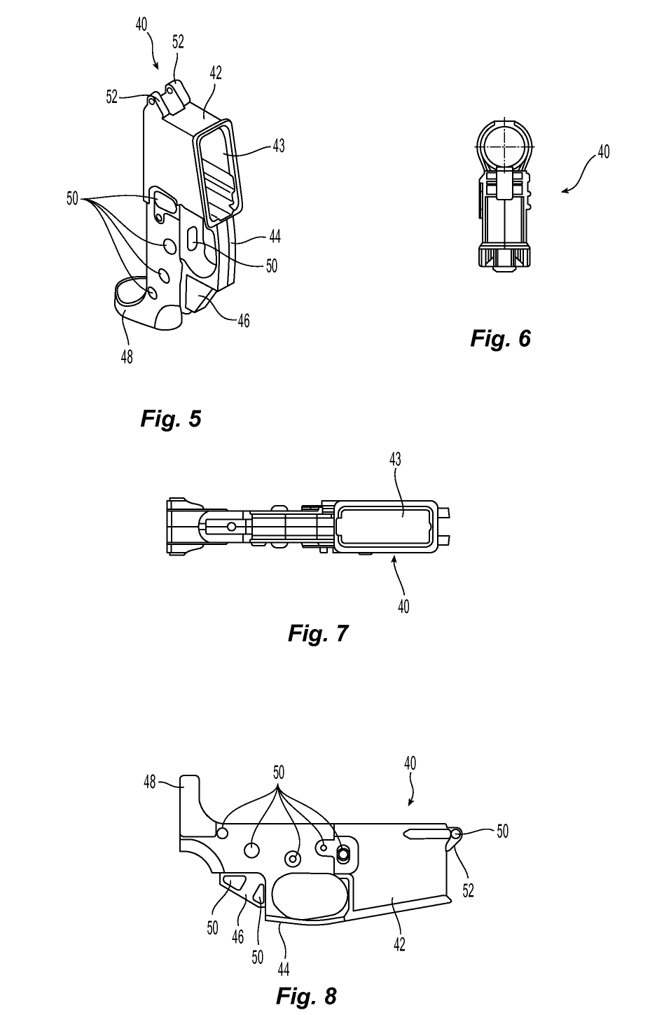

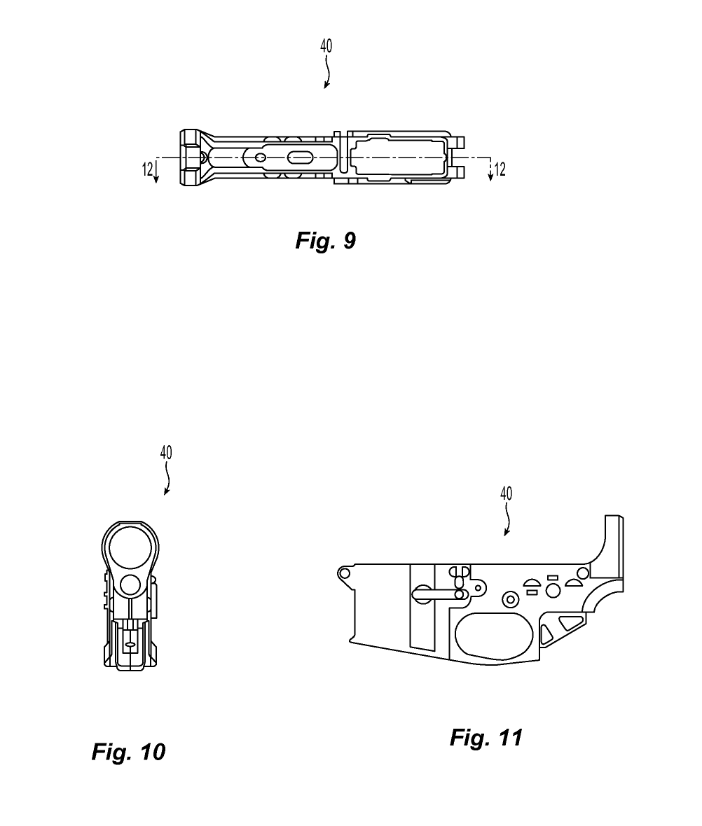

Lower receiver 40 is shown in greater detail in FIGS. 5-12. The illustrated receiver 40 is formed by injection molding a thixotropic, semisolid magnesium alloy and subsequently applying a nickel coating using an electroless nickel plating process. In this regard, it is noted that lower receivers for AR-style rifles are most commonly forged aluminum parts. Magnesium is lighter than aluminum and the use of a magnesium alloy can provide a weight reduction of approximately 35% compared to aluminum. A forged aluminum receiver also requires working and extensive machining.

In the illustrated embodiment, receiver 40 is formed using an AZ91D magnesium alloy. The composition of AZ91D magnesium alloys is known in the art and includes 8.5-9.5% Al, 0.45-0.90% Zn, 0.17-0.4% Mn, ≦0.05% Si, ≦0.025% Cu, ≦0.001% Ni, and <0.004% Fe with Mg forming the balance of the alloy. This alloy has high strength and good corrosion resistance and is often used for the housings of electric appliances.

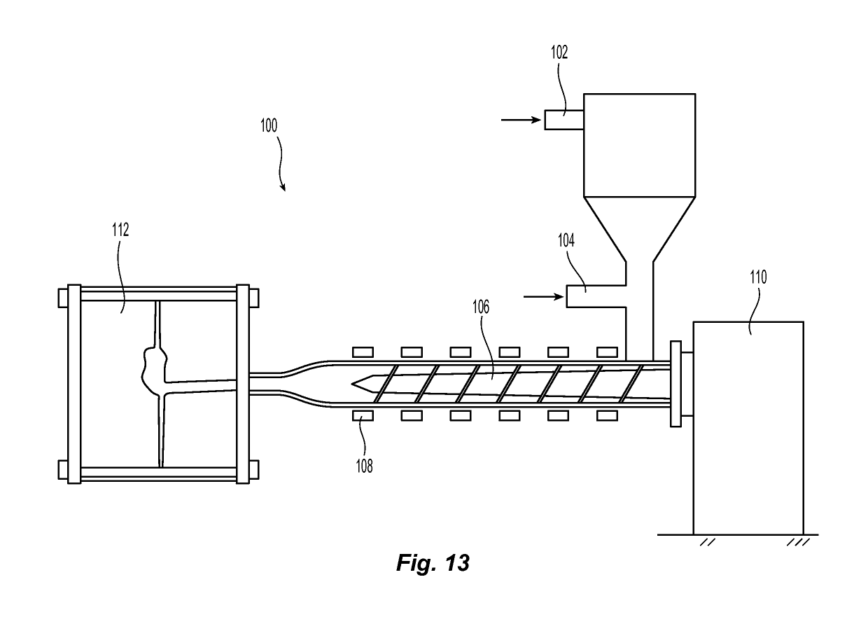

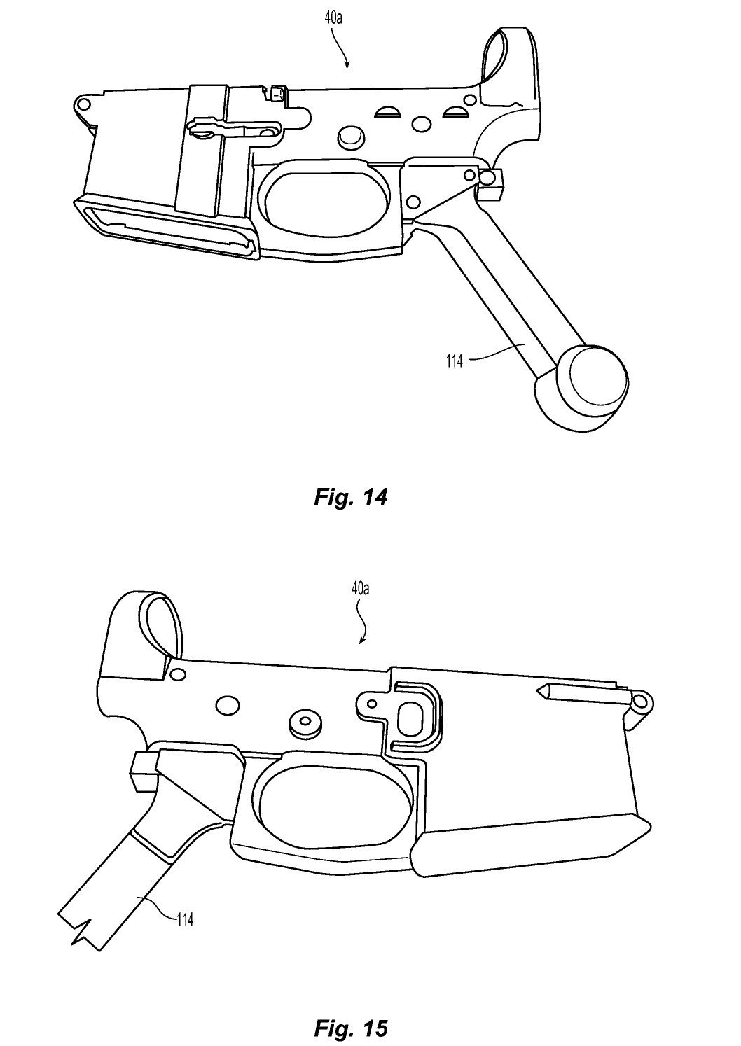

The thixotropic injection molding process used to form receiver 40 is schematically depicted in FIG. 13. Molding machine 100 includes a supply system 102 for feeding magnesium chips and an inert gas supply 104. The introduction of an inert gas such as argon prevents the magnesium from igniting. The magnesium chips and inert gas are fed into an injector barrel housing a screw 106. Heating elements 108 heat the content of the barrel. Heating elements 108 partially melt the magnesium chips while screw 106 provides the shearing force necessary to create a thixotropic slurry out of the semi-molten magnesium. Injector mechanism and accumulator 110 accumulate and then force the thixotropic magnesium into mold 112 under high pressure. After allowing the magnesium to cool within mold 112, the mold is opened to remove the lower receiver 40. FIGS. 14 and 15 depict the lower receiver after it has been removed from a mold and before any secondary processing has been performed on receiver. In FIGS. 14 and 15 the unfinished lower receiver is identified by reference numeral 40a.

The use of a thixotropic injection molding process to form receiver 40 provides several advantages over conventional die casting methods. Compared to die casting, thixotropic injection molding typically provides a laminar melt flow at a lower temperature which provides for quicker cooling with less shrinkage and higher dimensional accuracy. Thixotropic injection molding also typically results in higher densities and lower porosity. The dimensional stability and tight tolerances obtainable by thixotropic injection molding is result of several factors including laminar flow of the thixotropic slurry into the mold, the high pressures used when filling the mold and rapid solidification.

The high dimensional stability, tight tolerances and low draft obtainable by thixotropic injection molding of a magnesium alloy allows for the molding of complex geometries. The molded receiver 40 also has a semi-smooth surface. After molding, and without any post-molding processing, the surface of receiver 40 has a surface roughness, Rₐ, of approximately 35 microinches to approximately 60 microinches (approximately 0.00089 mm to approximately 0.0015 mm). The semi-smooth skin and ability to mold complex geometries held to tight tolerances, allows receiver 40 to be molded with preformed openings and other design features that would typically require significant machining to form. Furthermore, with regard to small number of features that are machined in receiver 40, magnesium is a relatively easy material to machine.

Minimizing the machining of receiver 40 is advantageous not only for reasons of manufacturing efficiency but also because it reduces the small particles of magnesium that are generated during the machining process. Small particles of magnesium are relatively easily ignited and thus must be carefully handled and minimizing the volume of such particles is advantageous. Thus, it can be economically advantageous to form an opening in receiver 40 during the molding process even when a machining operation is later used to provide a more tightly controlled surface on the opening because of the resulting reduction in magnesium particles generated during the machining operation. Although the disclosed embodiment advantageously minimizes the amount of machining required to finish lower receiver 40 by forming substantially all openings and slots in receiver 40 during the molding process, alternative embodiments may also be employed which require most, if not all, of the openings and slots in receiver 40 to be machined in their entirety.

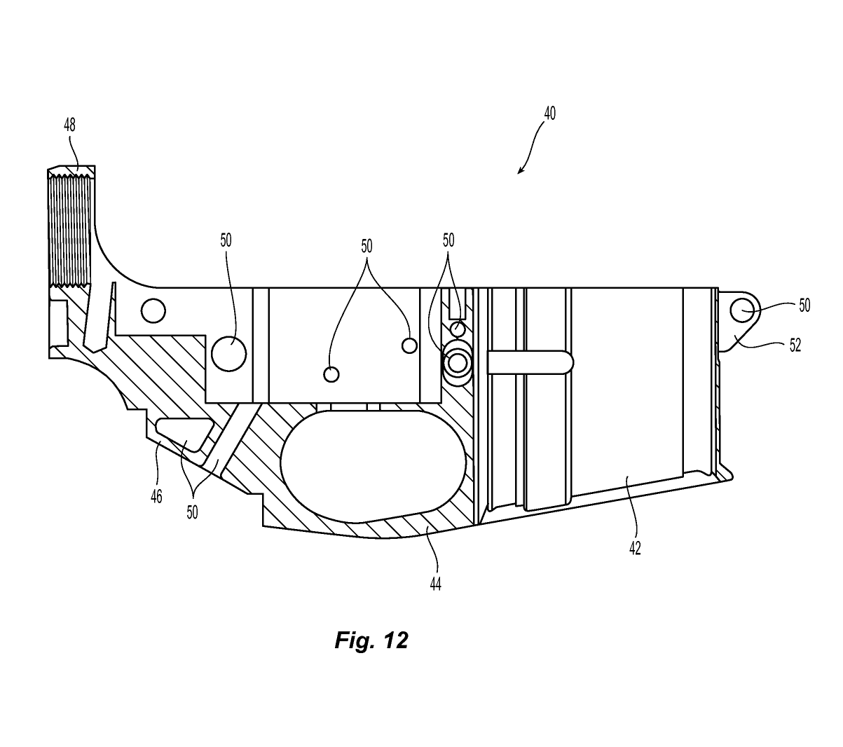

As mentioned above, lower receiver 40 is illustrated in FIGS. 5-12. Receiver 40 includes a magazine port 42 which defines an opening 43 for receiving a magazine, a trigger guard 44, a mounting bracket 46 for attachment of a pistol grip, a threaded opening 48 for attachment of an extension tube, several small openings/slots 50 through the sidewalls of the receiver and pivot brackets 52 for pivotally and detachably mounting an upper receiver assembly 34 to lower receiver 40, see e.g., FIGS. 5 and 12. It is noted that assembly 34 includes an upper receiver 33 having a barrel 35 attached thereto and the pivotal connection of upper receiver 33 to lower receiver 40 at pivot brackets 52 thereby operably couples barrel 35 to lower receiver 40. Openings 50 allow for installation of pins used in the securement of the trigger assembly. Openings 50 also allow for the projection of parts, e.g., one opening 50 facilitates the mounting of a selector that enables a user to put engage the safety of the firearm.

It is noted that the trigger guard 44 of lower receiver 40 shown in FIGS. 5-12 differs slightly from that depicted in FIG. 4. In FIG. 4, the trigger guard includes a detachable member. In FIGS. 5-12, trigger guard 44 is unitary and fully encloses the trigger area. Both embodiments can be employed with the present invention as well as various other modifications.

Text may also be present on receiver 40 such as on the outside of magazine port 42. Advantageously, the text is formed when the ejector pin impacts receiver 40 to eject it from the mold and simultaneously stamps the text in receiver 40. For example, the stamped text may identify the manufacturer of the receiver. The serial number must be unique for each receiver 40 and, thus, the text corresponding to the serial number of receiver 40 will typically be individually machined on each receiver instead of being stamped.

As can be seen in FIGS. 14 and 15, a sprue 114 extends from the unfinished lower receiver 40a upon removal of receiver 40a from the mold. In the illustrated embodiment sprue 114 is located at bracket 46 and, thus, several of the surfaces of bracket 46 are machined. Although limited machining of the molded body 40a is required, a significant proportion of the overall surface area of the lower receiver does not require machining. Alternative embodiments of the present invention may also be employed which involve machining either less or more of the surface area of the molded part.

After molding and machining the lower receiver, it is tumbled in a ceramic media for deburring, then cleaned and plated. As discussed above, only a relatively minimal amount of machining is required before plating receiver 40. Once plated, receiver 40 is completed can be assembled in a firearm 30.

As mentioned above, an electroless nickel plating process is used to plate receiver 40. The electroless nickel plating process is an auto-catalytic chemical process that deposits a nickel-phosphorus layer on receiver 40. In an electroless nickel plating process, a reducing agent is used to react with metal ions to deposit metal on the object being plated. In the illustrated example, a layer of nickel is deposited on receiver 40. Unlike electroplating, electroless nickel plating does not require the use of an electrical current to form a deposit on the work piece. The absence of flux-density and power supply variations allows the electroless nickel plating process to provide a more even deposit on the complex geometry of receiver 40 than would an electroplating process. The use of an electroless nickel plating process also provides receiver 40 with a more durable coating than would a conventional ion-exchange chromating process.

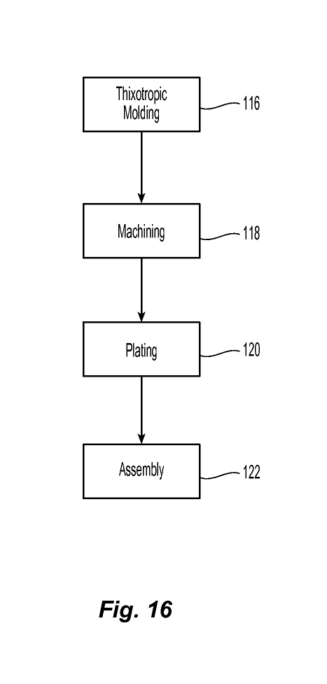

FIG. 16 provides a flow chart representing the manufacturing process discussed above. Box 116 represents the thixotropic molding of a receiver 40. After molding, the receiver is subjected to further processing which typically includes machining as represented by box 118. As mentioned above, thixotropic molding allows for the reduction in the amount of machining required to finish receiver 40. It will generally be desirable to plate receiver 40 as represented by box 120. After receiver 40 is finished, it can be assembled into a firearm as depicted by box 122.

While the present invention has been illustrated and described in the context of a lower receiver for an AR-style rifle, the present invention may be utilized with other firearm components and with receivers and other firearm components for other styles of firearms. For example, the upper receiver of an AR-style rifle could be manufactured in the same manner described above for lower receiver 40. Similarly, many of the individual parts forming the remainder of firearm 30 could be formed out of a magnesium alloy manufactured as described above. Receivers and parts of other firearms, such as bolt-action rifles and handguns, could also be manufactured using the process described above for receiver 40. With regard to handguns, it is noted that the “receiver” of a handgun is often referred to as the frame and for many models of handguns, the process described above with regard to receiver 40 would provide a handgun frame with the necessary physical properties to perform satisfactorily.

While this invention has been described as having an exemplary design, the present invention may be further modified within the spirit and scope of this disclosure. This application is therefore intended to cover any variations, uses, or adaptations of the invention using its general principles.

What is claimed is:

1. A firearm comprising:
a receiver with a thixotropically molded magnesium alloy body;
a trigger assembly operably coupled with the receiver; and
a barrel operably coupled with the receiver.

2. The firearm of claim 1 wherein the firearm is a modular rifle having an upper receiver securable to the barrel and a lower receiver housing the trigger assembly, the upper receiver being securable with the lower receiver and wherein the magnesium alloy body is the lower receiver.

3. The firearm of claim 1 wherein the magnesium alloy body is nickel plated.

4. A firearm receiver comprising:
a thixotropically molded magnesium alloy body.

5. The firearm receiver of claim 4 wherein the firearm receiver is adapted for use in a modular rifle having an upper receiver securable to a barrel and a lower receiver housing a trigger assembly, the upper receiver being securable to the lower receiver and wherein the magnesium alloy body is adapted to form the lower receiver.

6. The firearm receiver of claim 4 wherein the magnesium alloy body is nickel plated.

7. A method of manufacturing a firearm receiver comprising:
thixotropically molding a magnesium alloy to form a molded body; and
further processing the molded body to form the receiver.

8. The method of claim 7 wherein the molded body defines substantially all openings and slots in the firearm receiver before conducting any post-molding processing steps on the molded body.

9. The method of claim 8 wherein the step of further processing the molded body includes electroless nickel plating the molded body.

10. The method of claim 9 wherein the molded body has a surface roughness, Rₐ, that is between approximately 35 microinches and approximately 60 microinches after molding and without any post-molding processing to smooth the surface.

11. The method of claim 10 wherein the molded body is formed out of an AZ91D magnesium alloy.

12. The method of claim 11 wherein the molded body is molded to have a configuration which adapts the molded body for use in a modular rifle having both a lower receiver housing a trigger assembly and an upper receiver securable to a barrel and wherein the molded body is adapted to form the lower receiver.

13. The method of claim 12 further comprising the step of assembling a modular rifle with the molded body forming the lower receiver of the rifle.

14. The method of claim 7 wherein the step of further processing the molded body includes electroless nickel plating the molded body.

15. The method of claim 7 wherein the molded body has a surface roughness, Rₐ, that is between approximately 35 microinches and approximately 60 microinches after molding and without any post-molding processing to smooth the surface.

16. The method of claim 7 wherein the molded body is formed out of an AZ91D magnesium alloy.

17. The method of claim 7 wherein the molded body is molded to have a configuration which adapts the molded body for use in a modular rifle having both a lower receiver housing a trigger assembly and an upper receiver securable to a barrel.

18. The method of claim 17 wherein the molded body is adapted to form the lower receiver.

19. The method of claim 18 wherein the molded body defines substantially all openings and slots in the firearm receiver in a finished state before conducting any post-molding processing steps on the molded body.

20. The method of claim 18 wherein the molded body has a surface roughness, Rₐ, that is between approximately 35 microinches and approximately 60 microinches after molding and without any post-molding processing to smooth the surface.
